(19) United States
(12) Patent Application Publication
(10) Pub. No.: US 2025/0283421 A1
(43) Pub. Date: Sep. 11, 2025

(54) GAS TURBINE ENGINE INCLUDING STUB-TANDEM VARIABLE INLET GUIDE VANES

(71) Applicant: General Electric Company, Schenectady, NY (US)

(72) Inventors: Benjamin Iwrey, Indianapolis, IN (US); Sherif A. Abdelfattah, Mason, OH (US); Tyler James Alexander, Spring Lake, MI (US); Mackenzie Hock, Mason, OH (US); Christopher E. LaMaster, Franklin, OH (US); Keegan Nathaniel Mehrtens, Peabody, MA (US); Michal Chybowski, Warsaw (PL); Mark Stecher, Cincinnati, OH (US)

(21) Appl. No.: 18/597,639

(22) Filed: Mar. 6, 2024

(51) Int. Cl. F01D 17/18

(52) U.S. Cl. CPC F01D 17/18; F05D 2220/32

(57) ABSTRACT

Gas turbine engine including stub-tandem variable inlet guide vanes are disclosed. An example gas turbine engine includes a compressor, a variable inlet guide vane upstream of the compressor, and a part-span vane positioned between at least a portion of the variable inlet guide vane and the compressor in an axial direction defined by the gas turbine engine.

### FIELD OF DISCLOSURE

This disclosure relates generally to gas turbine engines and, more particularly, to gas turbine engine including stub-tandem variable inlet guide vanes.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section, thereby creating combustion gases. The combustion gases flow from the combustion section through a hot gas path defined within the turbine section and then exit the turbine section via the exhaust section.

### BRIEF DESCRIPTION OF THE DRAWINGS

FIG. 1 is a schematic cross-sectional view of an example engine for an aircraft in which examples disclosed herein can be implemented.

FIG. 2 illustrates first example variable inlet guide vanes that can be implemented in the engine of FIG. 1.

FIG. 3 illustrates second example variable inlet guide vanes that can be implemented in the engine of FIG. 1.

FIG. 4 illustrates third example variable inlet guide vanes that can be implemented in the engine of FIG. 1.

FIG. 5 illustrates an example actuation system to adjust a pitch of the variable inlet guide vanes of FIGS. 2, 3, and/or 4.

FIG. 6 illustrates another view of the example actuation system of FIG. 5.

FIG. 7 illustrates another example actuation system to adjust a pitch of the variable inlet guide vanes of FIG. 3.

FIG. 8A illustrates a first example cross-section of the variable inlet guide vanes of FIG. 3 in association with the third example actuation system of FIG. 7.

FIG. 8B illustrates a second example cross-section of the variable inlet guide vanes of FIG. 3 in association with the third example actuation system of FIG. 7.

FIG. 8C illustrates a third example cross-section of the variable inlet guide vanes of FIG. 3 in association with the third example actuation system of FIG. 7.

FIG. 8D illustrates a fourth example cross-section of the variable inlet guide vanes of FIG. 3 in association with the third example actuation system of FIG. 7.

FIG. 9 illustrates another example actuation system to adjust a pitch of the variable inlet guide vanes of FIGS. 3 and/or 4.

FIG. 10 illustrates an example cross-section of the actuation system of FIG. 9.

FIG. 11 illustrates another example actuation system to adjust a pitch of the variable inlet guide vanes of FIGS. 3 and/or 4.

FIG. 12 illustrates an example cross-section of the actuation system of FIG. 9.

FIG. 13 illustrates another example actuation system to adjust a pitch of the variable inlet guide vanes of FIGS. 2, 3, and/or 4.

FIG. 14 illustrates another example actuation system to adjust a pitch of the variable inlet guide vanes of FIGS. 2, 3, and/or 4.

In general, the same reference numbers will be used throughout the drawing(s) and accompanying written description to refer to the same or like parts. The figures are not necessarily to scale. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Gas turbine engines include a fan section proximate to an intake of an engine. The fan section includes a plurality of circumferentially spaced apart fan blades. A rotating portion of the fan section including the fan blades is rotatably coupled to a low pressure (LP) compressor (e.g., booster) via an LP shaft. In some examples, the LP shaft includes an LP shaft portion and a fan shaft portion. To facilitate channeling the airflow from the fan section into the LP compressor, some known gas turbine engines include a plurality of circumferentially spaced apart inlet guide vanes.

Variable inlet guide vanes have an angular orientation (e.g., a pitch or stagger) that can be adjusted to obtain flow properties that improve engine performance (e.g., increase thrust, increase a pressure increase produced by (e.g., a pressure ratio of) the compressor, etc.). For example, a variable inlet guide vane can close (e.g., rotate in a first direction that causes the trailing edge of the vane to point further in an engine spool rotation direction than in a nominal position, rotate in a first direction that increases a difference between circumferential positions of a leading edge of the inlet guide vane and a trailing edge of the inlet guide vane). In this way, the air discharged from the vane passage carries a velocity component tangential to the engine spool rotation direction. This can be referred to as an increase in swirl (e.g., flow angle as measured in the circumferential direction relative to the engine axis, flow angle in the direction of spool rotation), which causes the rotor blade immediately downstream of the vane to encounter a different flow velocity (e.g., speed and angle) in a rotating frame of reference of the blade compared to when the variable inlet guide vane is in the nominal position. As a result of the variable inlet guide vane closing, the rotor blade typically experiences a reduced relative flow velocity and a reduced incidence compared to when the variable inlet guide vane is in the nominal position. As used herein, incidence refers to the angle between (i) a direction in which the working fluid (e.g., air) is flowing and (ii) an orientation of a leading edge of a blade or vane that the working fluid contacts. The reduced relative flow velocity and incidence causes the blade to perform less work. This, in turn, causes the blade to draw less flow. The variable inlet guide vane can open (e.g., rotate in a second direction opposite the first direction, rotate in a direction that causes the trailing edge of the vane to point further away from the engine spool rotation direction than in the nominal position) to provide an opposite aerodynamic effect to that of the variable inlet guide vane closing.

In single or multi-stage compressors, nonsynchronous vibration refers to a blade or vane vibration that is not an integer multiple of the engine spool rotational speed. Certain types of nonsynchronous vibration are due to the formation of discrete aerodynamic instabilities that rotate in the same direction as the rotor but at a lower speed. These instabilities change the unsteady aerodynamic loads experienced by the blades due to the difference in rotational speed between the blade and the instabilities, and that difference may coincide with a natural vibrational mode of the rotor structure. Nonsynchronous vibration can cause damage to the blades. The formation of these instabilities is related to the aerodynamic operating point approaching, but not reaching, the point of flowfield breakdown or stall.

High-pressure-ratio multistage compressors implement variable vane systems due to natural aerodynamic mismatch effects that occur during operation away from the aerodynamic design point (ADP). At a given rotational speed, each stage (e.g., rotor-stator pair) of the compressor can operate down to a minimum effective downstream throttle setting before encountering a stability limit, at which point the flowfield can no longer be sustained (e.g., at which point a stall would occur). This effective throttle setting is equivalent to the flow drawn by the stage immediately downstream. At a rotational speed below the ADP speed, each of the stages in the compressor naturally draws a lower flow than nominal. Accordingly, the furthest downstream stages draw a lower flow, which closes the effective throttle of the middle stages (e.g., increases the pressure ratio across the middle stages). This effective throttle closure forces the middle stages to operate closer to their stability limits and causes the middle stages to draw even less flow. The variable vanes in the middle stages may close to relieve the increased flow incidence, diffusion, and work experienced by the middle stages. However, the closure of the variable vanes causes the middle stages to draw even less flow, which in turn causes the upstream stages to experience an even greater effective throttle closure than the middle stages. As such, the front variable vanes (e.g., the inlet variable guide vane and one or more downstream variable vanes at a front of the compressor) close even further than the variable vanes of the middle stages to offset this impact to the stability margin (e.g., an amount of throttle closure relative to the current position at which the compressor would exceed a corresponding stability limit).

Further, the 2-dimensional (2D) effects occur spanwise and, thus, are observed in both the axial direction and the radial direction. The upstream rotor includes a lower radius ratio (e.g., ratio of hub radius to tip radius) than the downstream rotor, and the lower radius ratio creates a greater difference in an axial velocity profile from a hub of the blade to a tip of the blade (e.g., a >40% difference between hub and tip axial velocity with a rotor inlet radius ratio of 0.4). As the inlet guide vane rotates further (e.g., in a direction that increases a difference between circumferential positions of a leading edge of the inlet guide vane and a trailing edge of the inlet guide vane) to increase swirl, the difference in the axial velocity profile from the hub to the tip continues to increase. With a high radius ratio blade, a flow incidence (e.g., tip incidence)—which correlates with (e.g., is directly related to) nonsynchronous vibration and general operability risk—decreases as the variable inlet guide vane closes. However, the increased difference in the axial velocity profile of an upstream blade having a lower radius ratio causes the axial velocity of the airflow to encounter a significant decrease. Accordingly, while an increase in swirl can help reduce the flow incidence, a reduction in axial velocity can also result from the increase in swirl, which can remove or reduce a benefit provided by the increase in swirl and may result in nonsynchronous vibration. As used herein, tip incidence or flow incidence refers to the angle between a direction in which fluid (e.g., air) is flowing relative to an orientation of a surface at a tip of an airfoil that the fluid contacts. Tip incidence can be calculated based on an angle between the relative velocity vector and an axial or meridional direction in a velocity triangle.

Examples disclosed herein provide stub-tandem variable inlet guide vanes that control swirl distribution to reduce the flow incidence and nonsynchronous vibration encountered by airfoils in a compressor.

In some examples, the stub-tandem variable inlet guide vanes include a first variable inlet guide vane that spans from an inner radial edge of a flow path defined at an inlet of a compressor to an outer radial edge of the flow path. That is, the first variable inlet guide vane spans a radial distance of the flow path (e.g., a first variable pitch airfoil, a full-span vane, etc.). The stub-tandem variable inlet guide vanes also include a second variable inlet guide vane at least partially downstream of the first variable inlet guide vane. The second variable inlet guide vane spans only a portion of the radial distance of the flow path (e.g., a second variable pitch airfoil, a part-span vane, a variable part-span vane, etc.). Specifically, the second variable inlet guide vane includes (i) an outer radial edge at the outer radial edge of the flow path and (ii) an inner radial edge positioned in a mid-radial portion of the flow path (e.g., further from the inner radial edge of the flow path than an inner radial edge of the first variable inlet guide vane). As such, the first and second variable inlet guide vanes provide a second degree of freedom to control a tip incidence encountered by the downstream rotors and reduce nonsynchronous vibrations that the rotors encounter. Specifically, typical variable inlet guide vanes that span the full radial-length of the inlet provide a single degree of freedom to a spanwise swirl distribution. Advantageously, in examples disclosed herein, the first inlet guide vane provides a first degree of freedom that adjusts a swirl distribution across at least a portion of a radial length of the flow path, and the second (e.g., stub, part-span) variable inlet guide vane provides a second degree of freedom that can further adjust a swirl distribution near an outer radial boundary of the flow path.

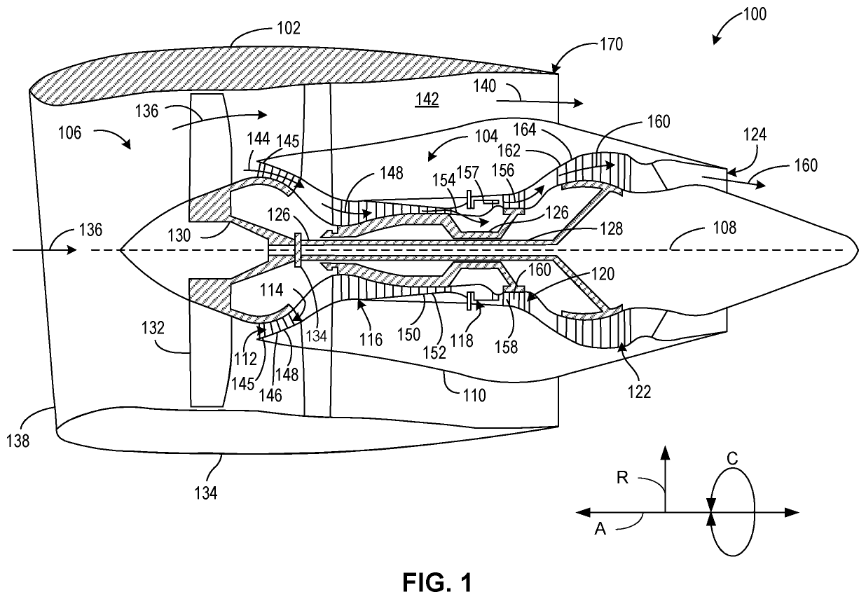

Referring now to the drawings, FIG. 1 is a schematic cross-sectional view of an example turbo engine 100 that can incorporate various examples disclosed herein. The example turbo engine 100 can be implemented on an aircraft and therefore referred to as an aircraft engine. In this example, the turbo engine 100 is a turbofan-type of engine. However, the principles of the present disclosure are also applicable to other types of engines, such as turboprop engines and engines without a nacelle, such as unducted fan (UDF) engines (sometimes referred to as propfans). Further, the example principles disclosed herein can be implemented on other types of engines, such as non-aircraft engines.

As shown in FIG. 1, the turbo engine 100 includes an outer bypass duct 102 (which may also be referred to as a nacelle, fan duct, or outer casing), a gas turbine engine 104 (which may also be referred to as a core turbine engine), and a fan section 106. The gas turbine engine 104 and the fan section 106 are disposed at least partially in the outer bypass duct 102. The gas turbine engine 104 is disposed downstream from the fan section 106 and drives the fan section 106 to produce forward thrust.

As shown in FIG. 1, the turbo engine 100 and/or the gas turbine engine 104 define a longitudinal or axial centerline axis 108 extending therethrough for reference. FIG. 1 also includes an annotated directional diagram with reference to an axial direction A, a radial direction R, and a circumferential direction C. In general, as used herein, the axial direction A is a direction that extends generally parallel to the centerline axis 108, the radial direction R is a direction that extends orthogonally outward from or inward toward the centerline axis 108, and the circumferential direction C is a direction that extends concentrically around the centerline axis 108. Further, as used herein, the term “forward” refers to a direction along the centerline axis 108 in the direction of movement of the turbo engine 100, such as to the left in FIG. 1, while the term “rearward” refers to a direction along the centerline axis 108 in the opposite direction, such as to the right in FIG. 1.

The gas turbine engine 104 includes a substantially tubular outer casing 110 (which may also be referred to as a mid-casing) that defines an annular inlet 112. The outer casing 110 of the gas turbine engine 104 can be formed from a single casing or multiple casings. The outer casing 110 encloses, in serial flow relationship, a compressor section having a booster or low pressure compressor 114 (“LP compressor 114”) and a high pressure compressor 116 (“HP compressor 116”), a combustion section 118, a turbine section having a high pressure turbine 120 (“HP turbine 120”) and a low pressure turbine 122 (“LP turbine 122”), and an exhaust section 124.

The gas turbine engine 104 includes a high pressure shaft 126 (“HP shaft 126”) that drivingly couples the HP turbine 120 and the HP compressor 116. The gas turbine engine 104 also includes a low pressure shaft 128 (“LP shaft 128”) that drivingly couples the LP turbine 122 and the LP compressor 114. The LP shaft 128 also couples to a fan shaft 130.

The fan section 106 includes a plurality of fan blades 132 that are coupled to and extend radially outward from the fan shaft 130. In some examples, the LP shaft 128 may couple directly to the fan shaft 130 (i.e., a direct-drive configuration). In alternative configurations, the LP shaft 128 may couple to the fan shaft 130 via a reduction gear 134 (i.e., an indirect-drive or geared-drive configuration). While in this example the gas turbine engine 104 includes two compressors and two turbines, in other examples, the gas turbine engine 104 may only include one compressor and one turbine. Further, in other examples, the gas turbine engine 104 can include more than two compressors and turbines. In such examples, the gas turbine engine 104 may include more than two drive shafts or spools.

As illustrated in FIG. 1, during operation of the turbo engine 100, air 136 enters an inlet portion 138 of the turbo engine 100. The air 136 is accelerated by the fan blades 132. A first portion 140 of the air 136 flows into a bypass airflow passage 142, while a second portion 144 of the air 136 flows into the inlet 112 of the gas turbine engine 104 (and, thus, into the LP compressor 114). Inlet guide vanes 145 are positioned proximate to the inlet 112 to help guide the flow of the second portion 144 of the air 136 to control downstream tip incidence and enhance engine performance. The inlet guide vanes 145 are stub-tandem (e.g., full span-part span, father-son) variable inlet guide vanes that reduce non-synchronous vibration, as discussed in further detail below. Downstream of the inlet guide vanes 145, one or more sequential stages of LP compressor stator vanes 146 and LP compressor rotor blades 148 coupled to the LP shaft 128 progressively compress the second portion 144 of the air 136 flowing through the LP compressor 114 en route to the HP compressor 116. Next, one or more sequential stages of HP compressor stator vanes 150 and HP compressor rotor blades 152 coupled to the HP shaft 126 further compress the second portion 144 of the air 136 flowing through the HP compressor 116. This provides compressed air 154 to the combustion section 118 where it mixes with fuel and burns to provide combustion gases 156. Fuel is injected into the combustion section 118 by one or more nozzles 157. The turbo engine 100 includes a fuel system to provide pressurized fuel through the nozzles 157 to the combustion section 118 of the gas turbine engine 104. Example fuel systems are disclosed in further detail herein.

The combustion gases 156 flow through the HP turbine 120 where one or more sequential stages of HP turbine stator vanes 158 and HP turbine rotor blades 160 coupled to the HP shaft 126 extract a first portion of kinetic and/or thermal energy. This energy extraction supports operation of the HP compressor 116. The combustion gases 156 then flow through the LP turbine 122 where one or more sequential stages of LP turbine stator vanes 162 and LP turbine rotor blades 164 coupled to the LP shaft 128 extract a second portion of thermal and/or kinetic energy therefrom. This energy extraction causes the LP shaft 128 to rotate, which supports operation of the LP compressor 114 and/or rotation of the fan shaft 130. The combustion gases 156 then exit the gas turbine engine 104 through the exhaust section 124 thereof. The combustion gases 156 mix with the first portion 140 of the air 136 from the bypass airflow passage 142. The combined gases exit an exhaust nozzle 170 (e.g., a converging/diverging nozzle) of the bypass airflow passage 142 to produce propulsive thrust.

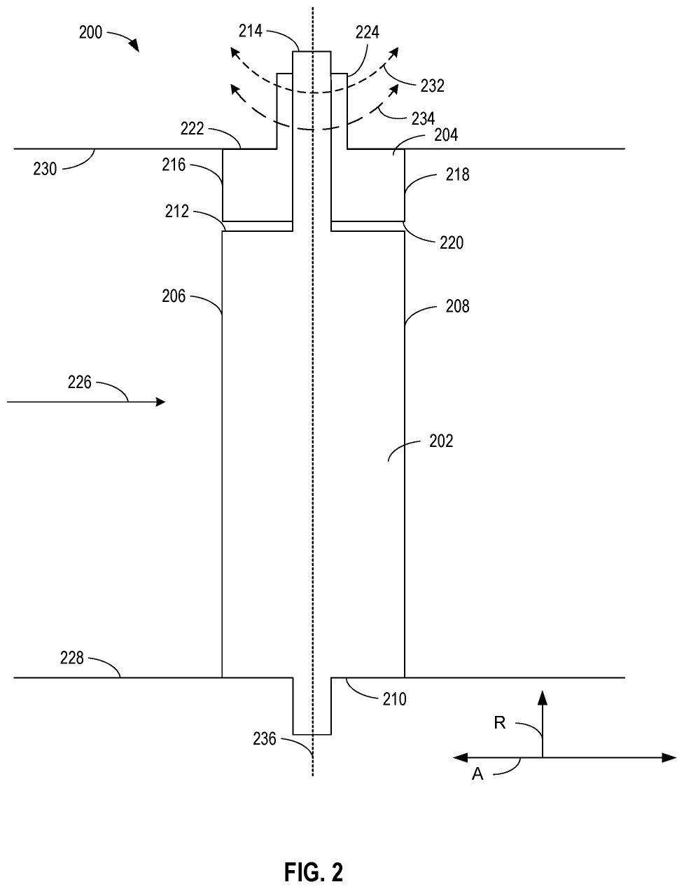

FIG. 2 illustrates first stub-tandem variable inlet guide vanes 200 that can implement the inlet guide vanes 145 of FIG. 1. The stub-tandem variable inlet guide vanes 200 of FIG. 2 include a first variable inlet guide vane 202 (e.g., a first part-span vane, a first variable pitch airfoil) and a second variable inlet guide vane 204 (e.g., a stub, a second part-span vane, a second variable pitch airfoil) that encounter the second portion 144 (FIG. 1) of the air 136 (FIG. 1) between the inlet 112 (FIG. 1) and the LP compressor 114 (FIG. 1). The first variable inlet guide vane 202 includes a first leading edge 206, a first trailing edge 208, a first inner radial edge 210, a first outer radial edge 212, and a first shaft 214. The second variable inlet guide vane 204 includes a second leading edge 216, a second trailing edge 218, a second inner radial edge 220, a second outer radial edge 222, and a second shaft 224.

In FIG. 2, the second portion 144 of the air 136 is in a flow path 226 defined between an inner radial surface 228 and an outer radial surface 230. For example, the inner radial surface 228 can be at least partially defined by the LP fan shaft 128 to which the LP compressor rotor blades 148 (FIG. 1) connect downstream of the stub-tandem variable inlet guide vanes 200. The outer radial surface 230 can be defined by an inner radial surface of the outer casing 110 (FIG. 1).

In FIG. 2, the second variable inlet guide vane 204 is supported at only one end (e.g., the second outer radial edge 222) while the other end (e.g., the second inner radial edge 220) is suspended in the flow path 226 between the inner radial surface 228 and the outer radial surface 230. Specifically, the second variable inlet guide vane 204 is supported via the second shaft 224 connected to the second outer radial edge 222. As such, the second variable inlet guide vane 204 is cantilevered. In FIG. 2, the first shaft 214 connects to both the first inner radial edge 210 and the first outer radial edge 212 and extends past both the inner radial surface 228 and the outer radial surface 230 to couple to a supporting structure (e.g., the LP fan shaft 128, the outer casing 110 (FIG. 1), an actuator, etc.). Accordingly, the first variable inlet guide vane 202 is supported at both the first inner radial edge 210 and the first outer radial edge 212. As such, the first variable inlet guide vane 202 is not cantilevered.

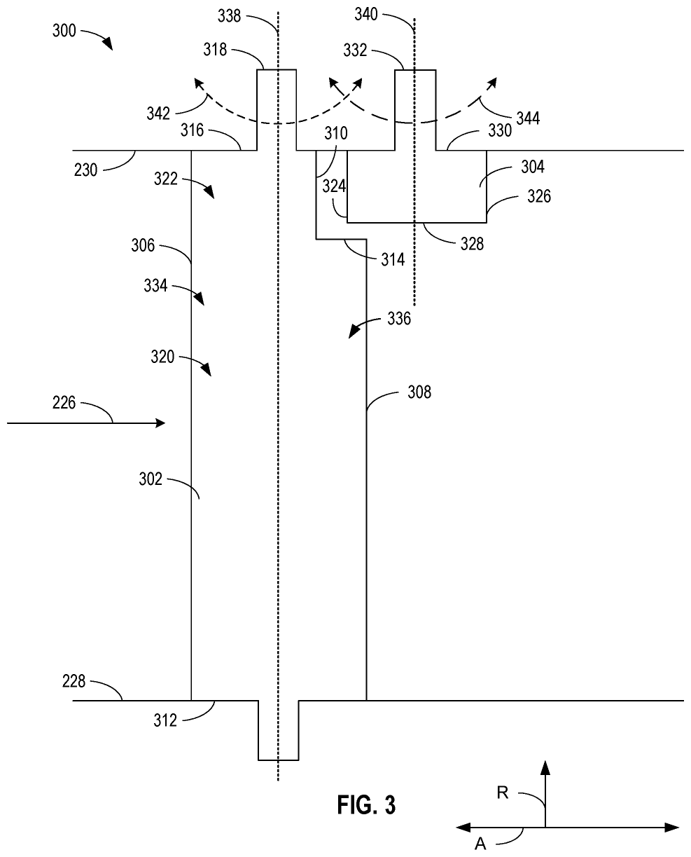

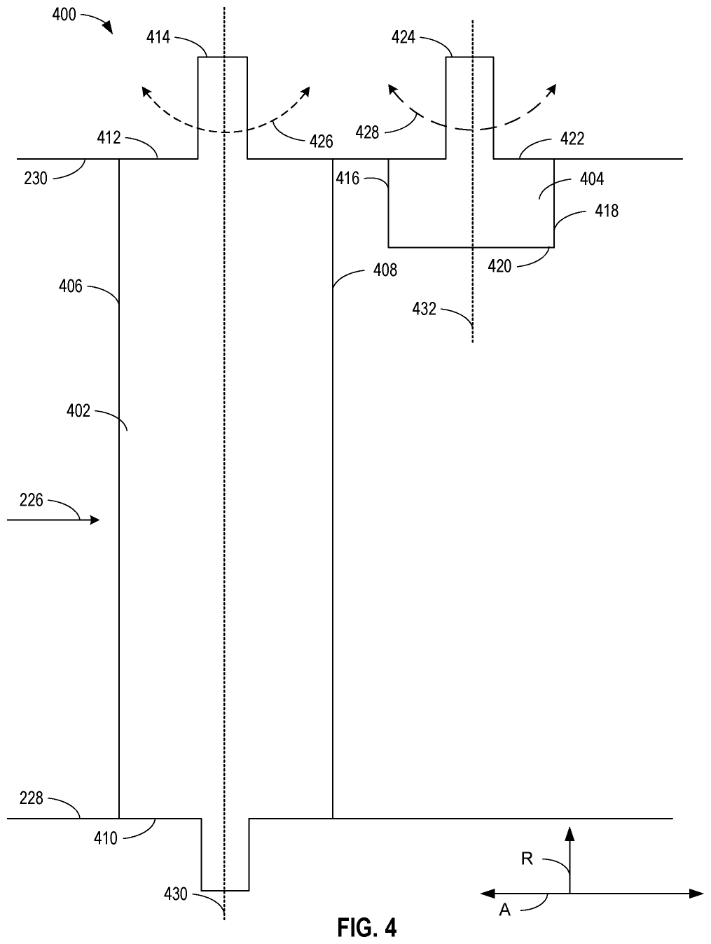

In FIG. 2, the first leading edge 206 of the first variable inlet guide vane 202 is aligned with the second leading edge 216 of the second variable inlet guide vane 204 in the axial direction A (e.g., in a same axial position). Similarly, the first trailing edge 208 of the first variable inlet guide vane 202 is aligned with the second trailing edge 218 of the second variable inlet guide vane 204 in the axial direction A (e.g., in a same axial position). In some other examples, the leading edges 206, 216 and/or the trailing edges 208, 218 are offset in the axial direction A, as discussed further in association with FIGS. 3 and 4.

In FIG. 2, the first inner radial edge 210 of the first variable inlet guide vane 202 is positioned at (e.g., is contiguous with) the inner radial surface 228. The second outer radial edge 222 of the second variable inlet guide vane 204 is positioned at (e.g., is defined at, is contiguous with) the outer radial surface 230. The first outer radial edge 212 of the first variable inlet guide vane 202 and the second inner radial edge 220 of the second variable inlet guide vane 204 are positioned in a mid-radial portion of the flow path 226 between the inner radial surface 228 and the outer radial surface 230. In some examples, the first variable inlet guide vane 202 spans at least 50% of a radial height of the flow path 226 (e.g., a distance between the inner radial surface 228 and the outer radial surface 230). For example, the first variable inlet guide vane 202 can span between 65% and 85% of the radial height of the flow path. In some examples, the first variable inlet guide vane 202 spans up to 90% of the radial height of the flow path. In this example, the second inner radial edge 220 is positioned between the first outer radial edge 212 and the outer radial surface 230. As such, the first variable inlet guide vane 202 occupies a separate radial portion of the flow path 226 than the second variable inlet guide vane 204. In some examples, the second variable inlet guide vane 204 spans from the outer radial surface 230 and occupies approximately 50% to approximately 10% of the radial height of the flow path 226. For example, the second variable inlet guide vane 204 can extend to the outer radial surface 230 and be separated from the inner radial surface 228 in the radial direction by between 50% and 90% of the radial height of the flow path 226.

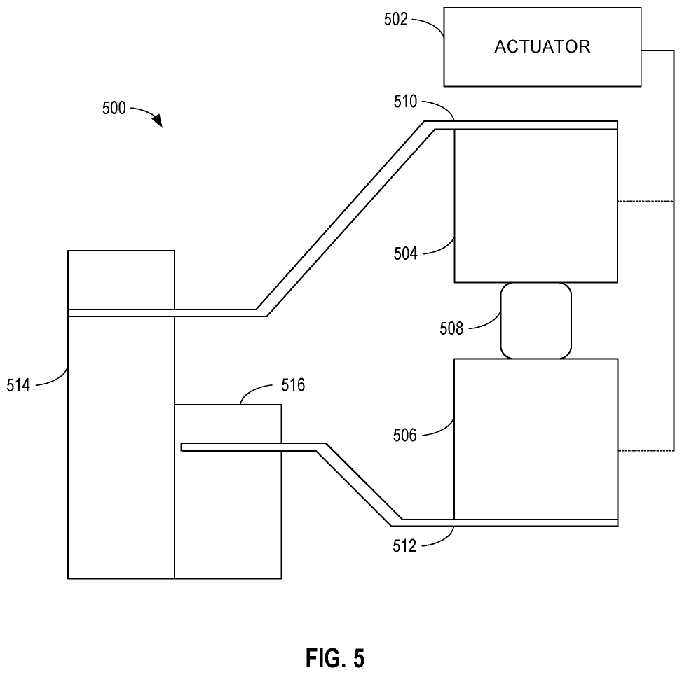

In some examples, the first shaft 214 and/or the second shaft 224 are coupled to one or more actuators, which adjust a pitch of the first variable inlet guide vane 202 along a first trajectory 232 and the second variable inlet guide vane 204 along a second trajectory 234. As a result, adjustments to the pitches of the inlet guide vanes 202, 204 can adjust the tip incidence encountered by downstream rotor blades (e.g., the LP compressor rotor blades 148 (FIG. 1), the HP compressor rotor blades 152 of FIG. 1) and, thus, control (e.g., reduce) nonsynchronous vibration encountered by the rotor blades. In this example, the first variable inlet guide vane 202 and the second variable inlet guide vane 204 share a same rotational axis 236. In some examples, the first variable inlet guide vane 202 and the second variable inlet guide vane 204 are actuated together in opposite directions or in different proportions to adjust the tip incidence and, thus, control (e.g., reduce) nonsynchronous vibration encountered by the compressor rotor blades. In some other examples, the first variable inlet guide vane 202 and the second variable inlet guide vane 204 are independently actuated. In some examples, the first outer radial edge 212 is positioned as close to the second inner radial edge 220 as manufacturing tolerances permit without causing the edges 212, 220 to rub as the vanes 202, 204 rotate. For example, the first outer radial edge 212 can be separated from the second inner radial edge 220 by a distance from 0.005 inches (in.) to 0.050 (in.). Example actuation mechanisms associated with the stub-tandem variable inlet guide vanes 200 of FIG. 2 are discussed further in association with FIGS. 5, 6, 13, and/or 14.

FIG. 3 illustrates second stub-tandem variable inlet guide vanes 300 that can implement the inlet guide vanes 145 of FIG. 1. The stub-tandem variable inlet guide vanes 300 of FIG. 3 include a first variable inlet guide vane 302 (e.g., a full-span vane, a first variable pitch airfoil) and a second variable inlet guide vane 304 (e.g., a stub, a part-span vane, a second variable pitch airfoil) that encounter the second portion 144 (FIG. 1) of the air 136 (FIG. 1) between the inlet 112 (FIG. 1) and the LP compressor 114 (FIG. 1). The first variable inlet guide vane 302 includes a first leading edge 306, a first trailing edge 308, a second trailing edge 310, a first inner radial edge 312, a first outer radial edge 314, a second outer radial edge 316, and a first shaft 318. More particularly, an inner radial portion 320 of the first variable inlet guide vane 302 includes the first inner radial edge 312, the first trailing edge 308, and the first outer radial edge 314. The first shaft 318 connects to the first inner radial edge 312 and the second outer radial edge 316 and extends past the inner radial surface 228 and the outer radial surface 230 to couple to a supporting structure, (e.g., the LP fan shaft 128 (FIG. 1), the outer casing 110 (FIG. 1), an actuator, etc.). As such, the first variable inlet guide vane 302 is not cantilevered. The second variable inlet guide vane 304 includes a second leading edge 324, a third trailing edge 326, a second inner radial edge 328, a third outer radial edge 330, and a second shaft 332. The second inner radial edge 328 is suspended in the flow path 226 between the inner radial surface 228 and the outer radial surface 230. Accordingly, the second variable inlet guide vane 304 is cantilevered.

In FIG. 3, an outer radial portion 322 of the first variable inlet guide vane 302 is defined outward of the first outer radial edge 314 in the radial direction R and includes the second trailing edge 310 and the second outer radial edge 316. Further, a leading portion 334 (e.g., an upstream portion) of the first variable inlet guide vane 302 is defined between the first leading edge 306 and the second trailing edge 310 in the axial direction A. A trailing portion 336 (e.g., a downstream portion) of the first variable inlet guide vane 302 is defined between the second trailing edge 310 and the first trailing edge 308 in the axial direction A.

In FIG. 3, the first inner radial edge 312 of the first variable inlet guide vane 302 is positioned at (e.g., is defined at, is contiguous with) the inner radial surface 228 of the flow path 226. The second outer radial edge 316 of the first variable inlet guide vane 302 and the third outer radial edge 330 of the second variable inlet guide vane 304 are positioned at (e.g., are defined at, are contiguous with) the outer radial surface 230 of the flow path 226. As such, the leading portion 334 of the first variable inlet guide vane 302 spans from the inner radial surface 228 to the outer radial surface 230 (e.g., spans a height of the flow path 226). The second inner radial edge 328 is positioned between the first outer radial edge 314 and the third outer radial edge 330 in the radial direction R. As such, the trailing portion 336 of the first variable inlet guide vane 302 spans only a portion of the height of the flow path 226 between the first inner radial edge 312 and the first outer radial edge 314. In some examples, the second variable inlet guide vane 304 spans from the outer radial surface 230 and occupies from approximately 50% to approximately 10% of the radial height of the flow path 226. Moreover, the second variable inlet guide vane 304 is aligned with the outer radial portion 322 of the first variable inlet guide vane 302 in the radial direction R. The second variable inlet guide vane 304 is positioned downstream of the outer radial portion 322. More particularly, the second leading edge 324 is positioned between the first trailing edge 308 and the second trailing edge 310 in the axial direction A. Additionally, the third trailing edge 326 is positioned aft of the first trailing edge 308.

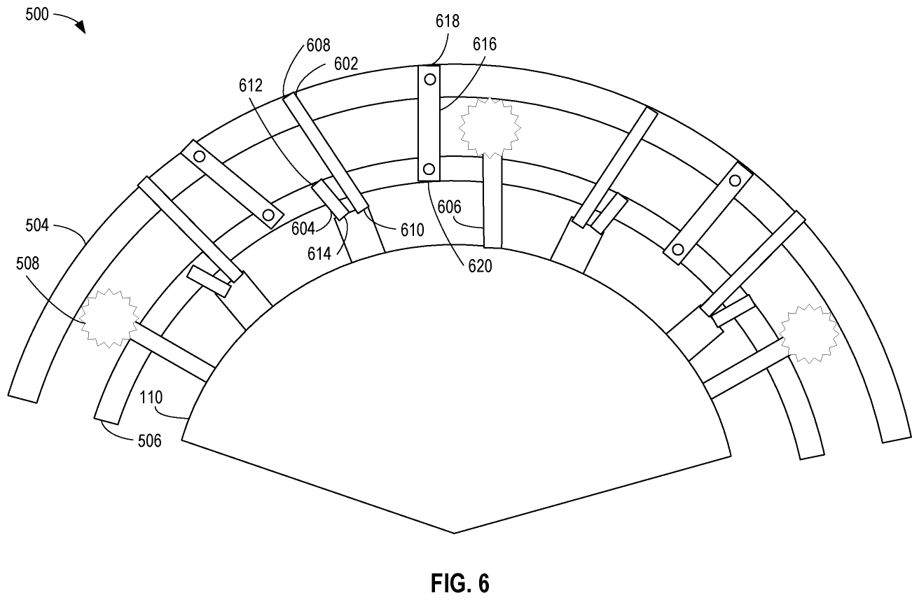

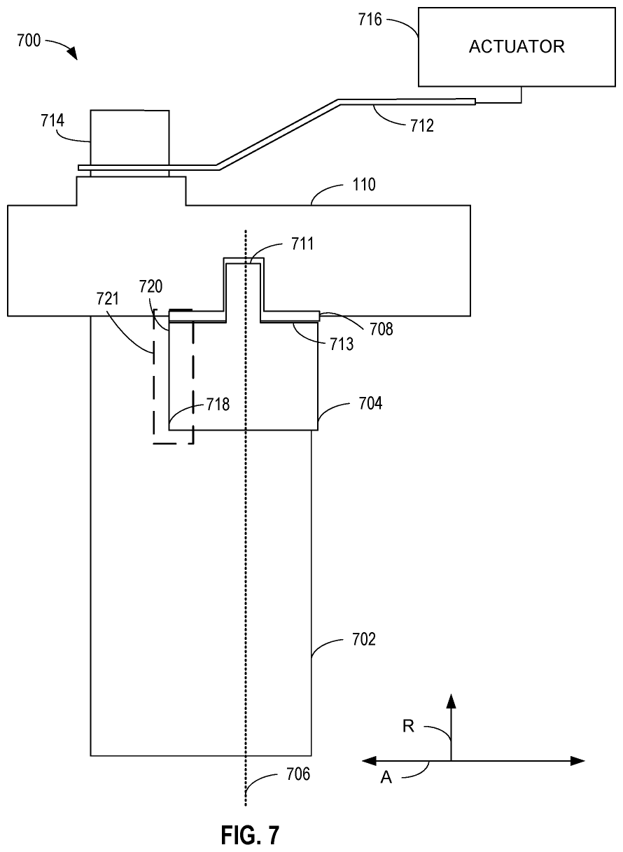

In some examples, the first shaft 318 and/or the second shaft 332 are coupled to one or more actuators, which adjust a pitch of the first variable inlet guide vane 302 along a first trajectory 342 and the second variable inlet guide vane 304 along a second trajectory 344. As a result, adjustments to the pitches of the inlet guide vanes 302, 304 can adjust the tip incidence encountered by downstream rotor blades (e.g., the LP compressor rotor blades 148, the HP compressor rotor blades 152 of FIG. 1) and, thus, control (e.g., reduce) nonsynchronous vibration encountered by the rotor blades. In this example, the first shaft 318 defines a first rotational axis 338, and the second shaft 332 defines a second rotational axis 340 downstream of the first rotational axis 338. In some examples, the second rotational axis 340 is positioned downstream of the first trailing edge 308. In some other examples, the second rotational axis 340 is positioned upstream of the first trailing edge 308 and overlaps the trailing portion 336 of the first variable inlet guide vane 302, as shown in the illustrated example of FIG. 7. In some such examples, the third trailing edge 326 has a same axial position as the first trailing edge 308. In some other such examples, the third trailing edge 326 is still downstream of the first trailing edge 308.

In some examples, the first variable inlet guide vane 302 and the second variable inlet guide vane 304 are actuated together in opposite directions or in different proportions to adjust the tip incidence and, thus, control (e.g., reduce) nonsynchronous vibration encountered by the compressor rotor blades. In some other examples, the first variable inlet guide vane 302 and the second variable inlet guide vane 304 are independently actuated. Example actuation mechanisms associated with the stub-tandem variable inlet guide vanes 300 of FIG. 3 are discussed further in association with FIGS. 5, 6, 7, 8A-8D, 9, 10, 11, 12, 13, and/or 14.

In some examples, the second leading edge 324 is positioned as close to the second trailing edge 310 in the axial direction A as manufacturing tolerances permit without causing the vanes 302, 304 to rub when rotating. In some other examples, the second leading edge 324 contacts and/or overlaps the first variable inlet guide vane 302 in the axial direction A. In some examples, the second inner radial edge 328 is positioned as close to the first outer radial edge 314 as manufacturing tolerances permit without causing the vanes 302, 304 to rub when rotating.

FIG. 4 illustrates third example stub-tandem variable inlet guide vanes 400 that can implement the inlet guide vanes 145 of FIG. 1. The stub-tandem variable inlet guide vanes 400 of FIG. 4 include a first variable inlet guide vane 402 (e.g., a full-span vane, a first variable pitch airfoil) and a second variable inlet guide vane 404 (e.g., a part-span vane, a second variable pitch airfoil) that encounter the second portion 144 (FIG. 1) of the air 136 (FIG. 1) between the inlet 112 (FIG. 1) and the LP compressor 114 (FIG. 1). The first variable inlet guide vane 402 includes a first leading edge 406, a first trailing edge 408, a first inner radial edge 410, a first outer radial edge 412, and a first shaft 414. The first shaft 414 connects to the first inner radial edge 410 and the first outer radial edge 412 and extends past the inner radial surface 228 and the outer radial surface 230 to couple to a supporting structure, (e.g., the LP fan shaft 128 (FIG. 1), the outer casing 110 (FIG. 1), an actuator, etc.). The second variable inlet guide vane 404 includes a second leading edge 416, a second trailing edge 418, a second inner radial edge 420, a second outer radial edge 422, and a second shaft 424. The second inner radial edge 420 is suspended in the flow path 226 between the inner radial surface 228 and the outer radial surface 230. Accordingly, the second variable inlet guide vane 404 is cantilevered.

In FIG. 4, the first inner radial edge 410 of the first variable inlet guide vane 402 is positioned at (e.g., is defined at, is contiguous with) the inner radial surface 228 of the flow path 226. The first outer radial edge 412 and the second outer radial edge 422 are positioned at (e.g., are defined at, are contiguous with) the outer radial surface 230 of the flow path 226. As such, the first variable inlet guide vane 402 spans a height of the flow path 226 from the inner radial surface 228 to the outer radial surface 230. In FIG. 4, the second inner radial edge 420 is defined at a mid-radial portion of the flow path 226 between the inner radial surface 228 and the outer radial surface 230. For example, the second variable inlet guide vane 404 can span from the outer radial surface 230 and occupy from approximately 50% to approximately 10% of the radial height of the flow path 226. In FIG. 4, the second leading edge 416 is positioned downstream of the first trailing edge 408.

In FIG. 4, the first shaft 414 and the second shaft 424 are coupled to one or more actuators, which adjust a pitch of the first variable inlet guide vane 402 along a first trajectory 426 and the second variable inlet guide vane 404 along a second trajectory 428. As a result, adjustments to the pitches of the variable inlet guide vanes 402, 404 can adjust the tip incidence encountered by downstream rotor blades (e.g., the LP compressor rotor blades 148, the HP compressor rotor blades 152 of FIG. 1) and, thus, control (e.g., reduce) nonsynchronous vibration encountered by the rotor blades. In this example, the first shaft 414 defines a first rotational axis 430, and the second shaft 424 defines a second rotational axis 432 downstream of the first rotational axis 430.

In some examples, the first variable inlet guide vane 402 and the second variable inlet guide vane 404 are actuated together in opposite directions or in different proportions to adjust the tip incidence and, thus, control (e.g., reduce) nonsynchronous vibration encountered by the compressor rotor blades. In some other examples, the first variable inlet guide vane 402 and the second variable inlet guide vane 404 are independently actuated. Example actuation mechanisms associated with the stub-tandem variable inlet guide vanes 400 of FIG. 4 are discussed further in association with FIGS. 5, 6, 7, 8A-8D, 9, 10, 11, 12, 13, and/or 14.

In some examples, the second leading edge 416 is positioned as close to the first trailing edge 408 in the axial direction A as manufacturing tolerances permit without causing the vanes 402, 404 to rub when rotating. In some other examples, the second leading edge 416 contacts and/or overlaps with the first variable inlet guide vane 402 in the axial direction A.

FIG. 5 illustrates a first actuation system 500 to adjust a pitch of the variable inlet guide vanes 200, 300, 400 of FIGS. 2, 3, and/or 4. The first actuation system 500 includes an actuator 502, a first ring 504 (e.g., an outer ring), a second ring 506 (e.g., an inner ring), a gear 508, a first lever arm 510, and a second lever arm 512. The first lever arm 510 couples a first shaft 514 (e.g., the first shaft 214 of FIG. 2, the first shaft 318 of FIG. 3, the first shaft 414 of FIG. 4) of a first variable inlet guide vane (e.g., the first variable inlet guide vane 202 of FIG. 2, the first variable inlet guide vane 302 of FIG. 3, the first variable inlet guide vane 402 of FIG. 4) to the first ring 504. The second lever arm 512 couples a second shaft 516 (e.g., the second shaft 224 of FIG. 2, the second shaft 332 of FIG. 3, the second shaft 424 of FIG. 4) of a second variable inlet guide vane (e.g., a stub, the second variable inlet guide vane 204 of FIG. 2, the second variable inlet guide vane 304 of FIG. 3, the second variable inlet guide vane 404 of FIG. 4) to the second ring 506. In this example, the actuation system 500 is positioned radially outward of the flow path 226 of FIGS. 2-4. For example, the actuation system 500 can be coupled to the outer casing 110 of FIG. 1, as discussed further in association with FIG. 6.

In FIG. 5, the actuator 502 is operatively coupled to the first ring 504 or the second ring 506. In some examples, the actuator 502 is implemented by a hydraulic pump or a servo motor that is operatively coupled to the first ring 504 or the second ring 506 via one or more bell cranks and/or crank and slider linkages. In FIG. 5, when the actuator 502 is coupled to the first ring 504, the actuator 502 can cause the first ring 504 to rotate in a first direction (e.g., clockwise), which causes the gear 508 to rotate in the first direction between the first ring 504 and the second ring 506. Further, the rotation of the gear 508 can cause the second ring 506 to rotate in a second direction (e.g., counterclockwise) opposite the first direction. Alternatively, when the actuator 502 is coupled to the second ring 506, the actuator 502 can cause the second ring 506 to rotate in the first direction or the second direction, which also causes the gear 508 and, in turn, the first ring 504 to rotate in the opposite direction. The rotation of the rings 504, 506 pivots the lever arms 510, 512, which, in turn, rotates the shafts 514, 516 to adjust a pitch of the vanes connected to the shafts 514, 516. As such, the actuation system 500 of FIG. 5 rotates the shafts 514, 516 and their associated vanes in opposite directions to control the tip incidence encountered by downstream rotor blades (e.g., the LP compressor rotor blades 148, the HP compressor rotor blades 152 of FIG. 1) and, thus, control (e.g., reduce) nonsynchronous vibration encountered by the rotor blades.

Although the shafts 514, 516 are shown in different axial positions in the illustrated example of FIG. 5, it should be understood that the shafts 514, 516 can be positioned in a same axial position when the actuation system 500 is utilized in conjunction with the variable inlet guide vanes 200 of FIG. 2. In such examples, the shaft 514, 516 that is positioned concentrically within the other shaft 516, 514 extends further radially outward to provide a surface to which the lever arm 510, 512 can attach.

FIG. 6 illustrates another view of the example actuation system 500 of FIG. 5. Specifically, FIG. 6 is a schematic illustration of an example axial cross-section of an engine (e.g., the engine 100 of FIG. 1) that includes the example actuation system 500 of FIG. 5. The actuation system 500 includes first linkages 602 to couple the first ring 504 to the outer casing 110, second linkages 604 to couple the second ring 506 to the outer casing 110, and third linkages 606 to couple the gears 508 to the outer casing 110. The first ring 504 is aligned with the second ring 506 in the axial direction A and positioned radially outward of the second ring 506. That is, the first ring 504 and the second ring 506 are concentric circles. In the illustrated example of FIG. 6, the actuator 502, the lever arms 510, 512, and the shafts 514, 516 are removed to show the linkages 602, 604, 606, the rings 504, 506, and the gear 508.

In FIG. 6, the first linkages 602, the second linkages 604, and the third linkages 606 enable the outer casing 110 to support a load of the rings 504, 506 and the gears 508. The first linkages 602 are circumferentially spaced apart to support the first ring 504. Similarly, the second linkages 604 are circumferentially spaced apart to support the second ring 506. The first linkages 602 include an outer radial end 608 and an inner radial end 610. In some examples, the outer radial end 608 is pivotably coupled to the first ring 504. In some examples, the inner radial end 610 is pivotably coupled to the outer casing 110. In some other examples, the inner radial end 610 is fixedly coupled to the outer casing 110. In such examples, the first linkages 602 include a link (not shown, extending from the outer radial end 608 into the page) to couple the outer radial end 608 to the first ring 504. In such examples, a portion of the first linkages 602 from the inner radial end 610 to the outer radial end 608 is fixed in position and the link extending from the outer radial end 608 to the first ring 504 is pivotable about the outer radial end 608 to provide support while enabling the first ring 504 to rotate. For example, the link of the first linkages 602 can be coupled to the outer radial end 608 via a pin that enables the link to pivot about the outer radial end 608. Further, an opposite end of the link can be coupled to the first ring 504 via another pin that enables an end of the link that couples to the first ring 504 for support to also pivot about the pin as the first ring 504 rotates. As such, the first linkages 602 enable the first ring 504 to rotate relative to the outer casing 110 to cause the shafts 514 (FIG. 5) and, in turn, the variable inlet guide vanes connected to the shafts 514 to rotate.

The second linkages 604 can be similar to the first linkages 602. That is, the second linkages 604 includes an outer radial end 612 and an inner radial end 614. In some examples, the outer radial end 612 is pivotably coupled to the second ring 506. In some examples, the inner radial end 614 is pivotably coupled to the outer casing 110. In some other examples, the inner radial end 614 is fixedly coupled to the outer casing 110. In such examples, the second linkages 604 include a link (not shown, extending from the outer radial end 612 into the page) to couple the outer radial end 612 to the second ring 506. In such examples, a portion of the second linkages 604 from the inner radial end 614 to the outer radial end 612 is fixed in position and the link extending from the outer radial end 612 to the second ring 506 is pivotable about the outer radial end 612 to provide support while enabling the second ring 506 to rotate. For example, the link of the second linkages 604 can be coupled to the outer radial end 612 via a pin that enables the link to pivot about the outer radial end 612. Further, an opposite end of the link can be coupled to the second ring 506 via another pin that enables an end of the link that couples to the second ring 506 for support to also pivot about the pin as the second ring 506 rotates. As such, the second linkages 604 enable the second ring 506 to rotate relative to the outer casing 110 to cause the shafts 516 (FIG. 5) and, in turn, the variable inlet guide vanes connected to the shafts 516 to rotate.

In FIG. 6, the third linkages 606 support the gears 508. For example, the third linkages 606 can be fixedly coupled to the outer casing 110 such that the third linkages 606 are immovable relative to the outer casing 110. In such examples, the third linkages 606 are coupled to and/or include a rod or pin that extends through the gears 508 at a rotational axis of the gears. As such, the third linkages 606 support the gears 508 and maintain the position of the gears relative to the outer casing 110. Accordingly, a rotation of the first ring 504 or the second ring 506 can cause the gears 508 to rotate in place to push the other ring 504, 506 in the opposite direction.

In FIG. 6, the actuation system 500 also includes fourth linkages 616 to couple the first ring 504 to the second ring 506. For example, the fourth linkages 616 can include a first end 618 pivotably coupled to the first ring 504 and a second end 620 pivotably coupled to the second ring 506. In some examples, the fourth linkages 616 limit a rotational displacement between the rings 504, 506. In some examples, the fourth linkages 616 relay support of the first ring 504 to the second ring 506 or support of the second ring 506 to the first ring 504 to enable the first linkages 602 or the second linkages 604 to be removed.

FIG. 7 illustrates another example actuation system 700 to adjust a pitch of a first variable inlet guide vane 702 (e.g., a full-span vane, a first variable pitch airfoil) and a second variable inlet guide vane 704 (e.g., a stub, a part-span vane, a second variable pitch airfoil). The first and second variable inlet guide vanes 702, 704 of FIG. 7 are similar to the variable inlet guide vanes 300 of FIG. 3. In the illustrated example of FIG. 7, an axial position of a rotational axis 706 of the second variable inlet guide vane 704 overlaps with an axial position of the first variable inlet guide vane 702. However, it should be understood that the actuation system 700 can be utilized in association with the variable inlet guide vanes 300 of FIG. 3 in which an axial position of the second rotational axis 340 (FIG. 3) of the second variable inlet guide vane 304 (FIG. 3) is positioned downstream of and does not overlap with the axial position of the first variable inlet guide vane 302 (FIG. 3). Additionally, the example actuation system 700 of FIG. 7 may be utilized with the variable inlet guide vanes 400 of FIG. 4.

In FIG. 7, the actuation system 700 also includes the outer casing 110 and a bushing 708 between an outer radial edge 713 of the second variable inlet guide vane 704. The outer casing 110 helps facilitate movement (e.g., rotation, an adjustment to an angular displacement) of the second variable inlet guide vane 704 relative to the outer casing 110. More particularly, the second variable inlet guide vane 704 includes a spindle 711 that is positioned in and rotatably coupled to the outer casing 110. The bushing 708 separates the spindle 711 and the outer radial edge 713 of the second variable inlet guide vane 704 from the outer casing 110. The actuation system 700 also includes a lever arm 712 coupled to a shaft 714 (e.g., the first shaft 318 of FIG. 3) of the first variable inlet guide vane 702. The actuation system 700 further includes an actuator 716 operatively coupled to the lever arm 712 to control rotation of the shaft 714. In some examples, the actuator 716 is operatively coupled to the lever arm 712 via a ring (e.g., the ring 504 (FIG. 5)) and/or other linkages (e.g., one or more bell cranks, one or more crank and slider linkages, etc.). The actuator 716 can be implemented by a hydraulic pump or a servo motor.

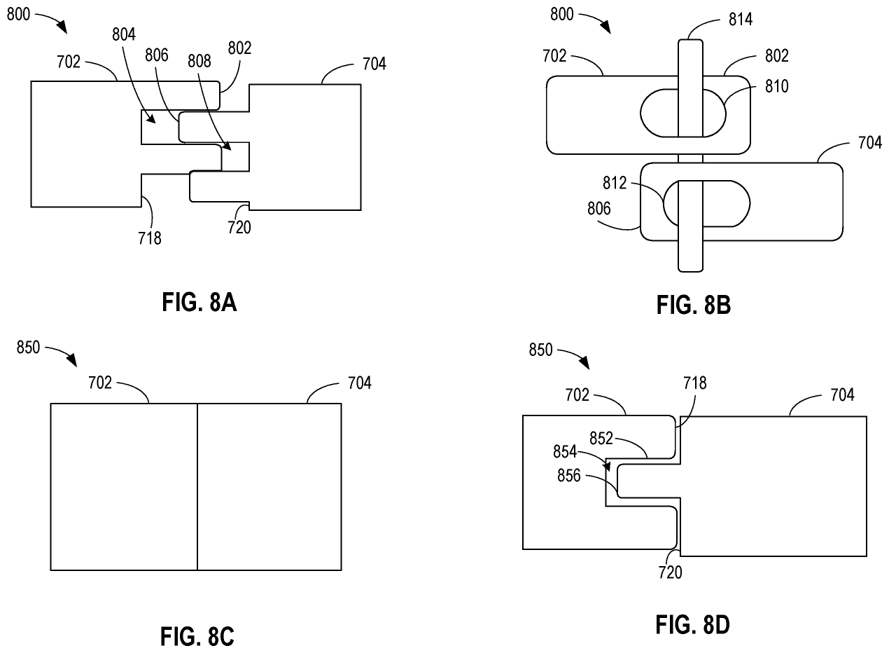

In the illustrated example of FIG. 7, an upper trailing edge 718 (e.g., the second trailing edge 310 (FIG. 3) of the first variable inlet guide vane 702 and a leading edge 720 (e.g., the second leading edge 324 (FIG. 3)) of the second variable inlet guide vane 704 include an interface 721, as discussed further in association with FIGS. 8A-8D. That is, the upper trailing edge 718 or a surface of the first variable inlet guide vane 702 is in contact with and/or overlaps in the axial direction A the leading edge 720 of the second variable inlet guide vane 704. As a result, a rotation of the shaft 714 causes the upper trailing edge 718 or a surface of the first variable inlet guide vane 702 to push against the second variable inlet guide vane 704, which produces a moment about the rotational axis 706 to turn the second variable inlet guide vane 704. Thus, when the actuator 716 causes the first variable inlet guide vane 702 to rotate in a first direction (e.g., clockwise), the first variable inlet guide vane 702 causes the second variable inlet guide vane 704 to rotate in a second direction opposite the first direction (e.g., counterclockwise).

FIGS. 8A-8B illustrate a first example interface 800 (e.g., a first example implementation of the interface 721 of FIG. 7) between the variable inlet guide vanes 702, 704 of FIG. 7 that causes rotation of the first variable inlet guide vane 702 to produce a rotation of the second variable inlet guide vane 704. FIG. 8A illustrates a side view of the interface 800 between the first variable inlet guide vane 702 and the second variable inlet guide vane 704. In FIG. 8A, the upper trailing edge 718 of the first variable inlet guide vane 702 includes first protrusions 802 (e.g., tabs, projections, ridges, etc.) and first slots 804 defined between the first protrusions 802. The leading edge 720 of the second variable inlet guide vane 704 includes second protrusions 806 and second slots 808 defined between the second protrusions 806. More particularly, the protrusions 802, 806 are spaced apart in the radial direction R to define the slots 804, 808 between the protrusions 802, 806. The first protrusions 802 of the first variable inlet guide vane 702 are positioned in the second slots 808 of the second variable inlet guide vane 704. Similarly, the second protrusions 806 of the second variable inlet guide vane 704 are positioned in the first slots 804 of the first variable inlet guide vane 702. The protrusions 802, 806 include orifices in which a pin is positioned to relay a rotation of the first variable inlet guide vane 702 to a rotation of the second variable inlet guide vane 704.

FIG. 8B illustrates a schematic top-down (e.g., radially inward) view of the interface 800 of FIG. 8A. The view of FIG. 8B is an idealized schematic view provided for purposes of illustration. In practice, portions of the protrusions 802, 806 that overlap in the axial direction A are stacked in the radial direction R such that the second protrusion 806 is positioned under the first protrusion 802 in a top-down view. As mentioned above, the first protrusion 802 includes a first orifice 810 and the second protrusion 806 includes a second orifice 812, and the interface 800 includes a pin 814 that is positioned in and extends through the orifices 810, 812. The protrusions 802, 806 are stacked to align the orifices 810, 812 and enable the pin 814 to pass through the orifices 810, 812 in the radial direction R. That is, the orifices 810, 812 define a slot in which the pin 814 is positioned. As a result, the pin 814 can relay movement of the upper trailing edge 718 to movement of the leading edge 720 that causes the second variable inlet guide vane 704 to rotate about the rotational axis 706 (FIG. 7). More particularly, as the actuator 716 (FIG. 7) rotates the first variable inlet guide vane 702 and causes the upper trailing edge 718 to move in a first direction (e.g., into the page in the view of FIG. 7), the pin 814 moves with the first protrusions 802 and applies a force to the second protrusions 806 that moves the leading edge 720 in the first direction. To enable the leading edge 720 to move in the first direction, the second variable inlet guide vane 704 rotates about the rotational axis 706 (FIG. 7). Furthermore, the rotation causes a trailing edge (not shown) (e.g., the third trailing edge 326) of the second variable inlet guide vane 704 to move in a second direction opposite the first direction (e.g., out of the page in the view of FIG. 7). As such, the interface 800 causes a counterclockwise rotation of the first variable inlet guide vane 702 to produce a clockwise rotation of the second variable inlet guide vane 704. In some examples, the orifices 810, 812 provide space for some movement of the pin 814 in the axial direction A to increase a range of motion of the variable inlet guide vanes 702, 704.

FIGS. 8C-8D illustrate a second example interface 850 (e.g., a second example implementation of the interface 721 of FIG. 7) of the variable inlet guide vanes 702, 704 of FIG. 7 that causes rotation of the first variable inlet guide vane 702 to produce a rotation of the second variable inlet guide vane 704. FIG. 8C illustrates a side or circumferential perspective of the interface 850 between the first variable inlet guide vane 702 and the second variable inlet guide vane 704. FIG. 8D illustrates a top-down (e.g., radially inward) view of the interface 850 of FIG. 8A. In FIG. 8D, the upper trailing edge 718 of the first variable inlet guide vane 702 includes an indentation 852 that defines a slot 854. The leading edge 720 of the second variable inlet guide vane 704 includes a protrusion 856 that is positioned in the slot 854. As such, when the first variable inlet guide vane 702 rotates, a surface of the indentation 852 contacts the protrusion 856 to apply a force that pushes the leading edge 720 of the second variable inlet guide vane 704 in a direction in which the upper trailing edge 718 is moving. As a result, the movement of the leading edge 720 causes the second variable inlet guide vane 704 to rotate about the rotational axis 706 (FIG. 7) in a direction opposite of the rotational direction of the first variable inlet guide vane 702.

Although FIG. 4 mentions that the second leading edge 416 (FIG. 4) is positioned aft of the first trailing edge 408 (FIG. 4), in some examples, the edges 408, 416 refer to ends of a side surface (e.g., a pressure surface, a suction surface). In such examples, the interface 850 can be utilized in conjunction with the third variable inlet guide vanes 400 of FIG. 4.

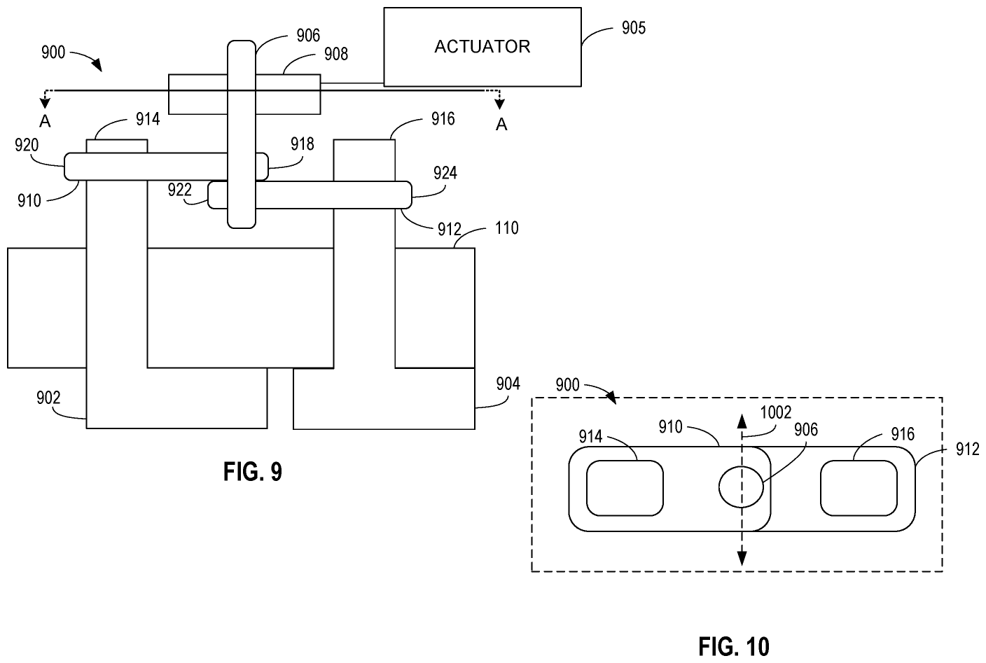

FIG. 9 illustrates another example actuation system 900 to adjust a pitch of a first variable inlet guide vanes 902 (e.g., the first variable inlet guide vane 302 of FIG. 3, the first variable inlet guide vane 402 of FIG. 4) and a second variable inlet guide vane 904 (e.g., the second variable inlet guide vane 304 of FIG. 3, the second variable inlet guide vanes 404 of FIG. 4). In FIG. 9, the actuation system 900 includes an actuator 905, a pin 906, a ring 908, a first lever arm 910, and a second lever arm 912. In FIG. 9, the first lever arm 910 is coupled to a first spindle 914 (e.g., a first shaft) of the first variable inlet guide vane 902. Similarly, the second lever arm 912 is coupled to a second spindle 916 (e.g., a second shaft) of the second variable inlet guide vane 904. In some examples, the actuation system 900 is positioned radially outward of the outer casing 110.

In FIG. 9, the actuator 905 controls a rotational position of the ring 908. That is, to adjust an angular displacement of the first and second variable inlet guide vanes 902, 904, the actuator 905 can rotate the ring 908. For example, the actuator 905 can be implemented by a hydraulic pump or a servo motor that is operatively coupled to the ring 908 via one or more bell cranks and/or crank and slider linkages (not shown) to enable the actuator 905 to control the rotational position of the ring 908. When the actuator 905 rotates the ring 908, the ring 908 moves the pin 906. The movement of the pin 906 is linear (e.g., into and/or out of the page) in the view of FIG. 9. In reality, the pin 906 moves in the circumferential direction C within the engine 100 of FIG. 1. More particularly, when implemented in the engine 100 of FIG. 1, the movement causes the pin 906 to revolve around the axial centerline axis 108 of FIG. 1. To that end, when implemented in the engine 100 of FIG. 1, the ring 908 is positioned in and/or around the outer casing 110 and concentrically around the flow path 226 (FIGS. 2-4) of the second portion 144 of the air 136. Further, the actuation system 900 includes a plurality of the pin 906 coupled to the ring 908 and circumferentially spaced apart to control the angular displacement of a plurality of the first and second variable inlet guide vanes 902, 904 at the inlet 112 (FIG. 1).

In FIG. 9, the lever arms 910, 912 are pivotably coupled to the pin 906. That is, the first lever arm 910 includes (i) a first end 918 (e.g., a trailing end) pivotably coupled to the pin 906 and (ii) a second end 920 (e.g., a leading end) fixedly coupled to the first spindle 914. Similarly, the second lever arm 912 includes (i) a first end 922 (e.g., a leading end) pivotably coupled to the pin 906 and (ii) a second end 924 (e.g., a trailing end) fixedly coupled to the second spindle 916. As a result, as the pin 906 moves, the lever arms 910, 912 rotate the spindles 914, 916 and, thus, the first and second variable inlet guide vanes 902, 904. The actuation system 900 of FIG. 9 causes the first and second variable inlet guide vanes 902, 904 to rotate in opposite directions. For example, when the ring 908 moves the pin 906 out of the page in the view of FIG. 9, the first lever arm 910 causes the first variable inlet guide vane 902 to rotate clockwise, and the second lever arm 912 causes the second variable inlet guide vane 904 to rotate counterclockwise.

FIG. 10 illustrates an example cross-section of a portion of the actuation system 900 of FIG. 9 taken along plane A-A of FIG. 9. Specifically, FIG. 10 illustrates a movement direction 1002 of the pin 906. In some examples, the movement direction 1002 corresponds to the circumferential direction C of FIG. 1 when the actuation system 900 is implemented in the engine 100 of FIG. 1. In FIG. 10, as the pin 906 moves in the movement direction 1002, the lever arms 910, 912 rotate the spindles 914, 916 to adjust a pitch of the first and second variable inlet guide vanes 902, 904.

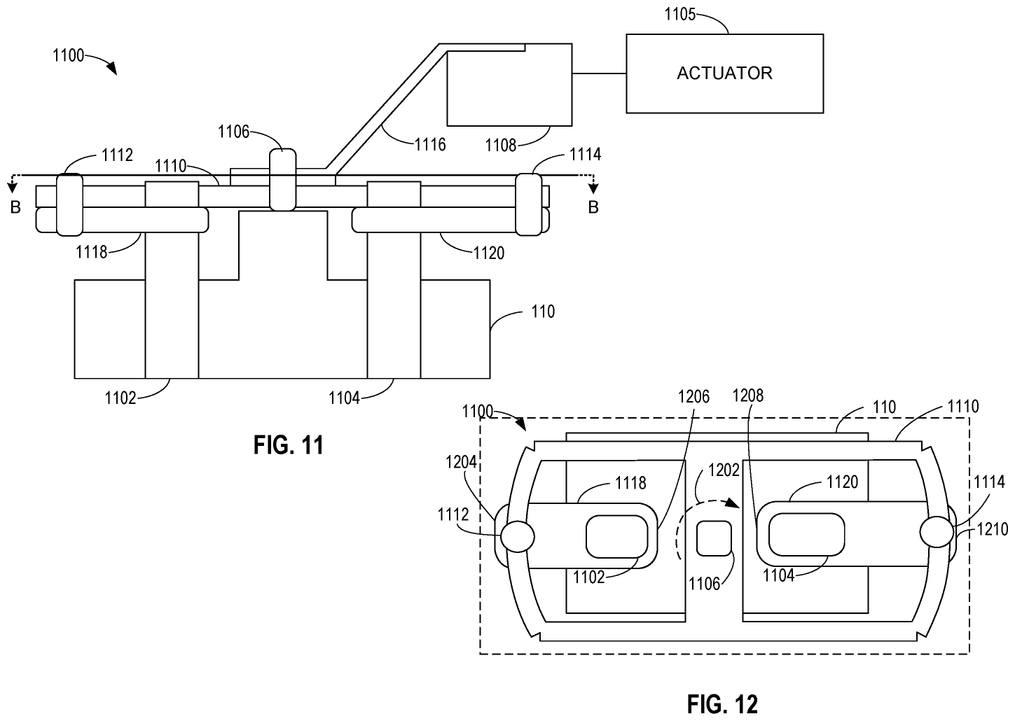

FIG. 11 illustrates another example actuation system 1100 to adjust a pitch of a first variable inlet guide vanes 1102 (e.g., the first variable inlet guide vane 302 of FIG. 3, the first variable inlet guide vane 402 of FIG. 4) and a second variable inlet guide vane 1104 (e.g., the second variable inlet guide vane 304 of FIG. 3, the second variable inlet guide vanes 404 of FIG. 4). In FIG. 11, the actuation system 1100 includes an actuator 1105, a first pin 1106, a ring 1108, a mounting 1110 (e.g., a frame, a holder, a linkage, etc.), a second pin 1112, a third pin 1114, a first lever arm 1116, a second lever arm 1118, and a third lever arm 1120. In FIG. 11, the first pin 1106 is rotatably coupled to the outer casing 110. The actuator 1105 controls a rotational position of the ring 1108. That is, to adjust an angular displacement of the first and second variable inlet guide vanes 1102, 1104, the actuator 1105 can rotate the ring 1108 in the circumferential direction C defined by the engine 100 of FIG. 1. For example, the actuator 1105 can be implemented by a hydraulic pump or a servo motor that is operatively coupled to the ring 1108 via one or more bell cranks and/or crank and slider linkages to enable the actuator 1105 to control the rotational position of the ring 1108. In FIG. 11, the first lever arm 1116 converts a rotation of the ring 1108 to a rotation of the first pin 1106.

In FIG. 11, the mounting 1110 is fixedly coupled to the first pin 1106. As a result, the mounting 1110 rotates with the first pin 1106. The second pin 1112 and the third pin 1114 are rotatably coupled to the mounting 1110. Additionally, the second pin 1112 is rotatably coupled to the second lever arm 1118, and the third pin 1114 is rotatably coupled to the third lever arm 1120. The second lever arm 1118 is also fixedly coupled to the first variable inlet guide vane 1102 (e.g., a shaft or spindle of the first variable inlet guide vane 1102). Similarly, the third lever arm 1120 is fixedly coupled to the second variable inlet guide vane 1104 (e.g., a shaft or spindle of the second variable inlet guide vane 1104).

In FIG. 11, when the actuator 1105 rotates the ring 1108 and, in turn, the first pin 1106 and the mounting 1110, the mounting 1110 revolves the second pin 1112 and the third pin 1114 around the first pin 1106. As a result, the second pin 1112 and the third pin 1114 cause the second lever arm 1118 and the third lever arm 1120 to pivot, which rotates the first variable inlet guide vane 1102 and the second variable inlet guide vane 1104. The actuation system 1100 of FIG. 11 causes the first and second variable inlet guide vanes 1102, 1104 to rotate in a same direction, as discussed further in association with FIG. 12.

FIG. 12 illustrates an example cross-section of a portion of the actuation system 1100 of FIG. 11 taken along plane B-B of FIG. 11. Specifically, FIG. 12 illustrates a movement direction 1202 of the first pin 1106 and the mounting 1110. In FIG. 12, as the first pin 1106 rotates (e.g., in the clockwise direction in the view of FIG. 12), the mounting 1110 rotates about the first pin 1106. As a result, the mounting 1110 moves the second pin 1112 to cause a leading end 1204 of the second lever arm 1118 to be positioned above a trailing end 1206 of the second lever arm 1118. As a result, the second lever arm 1118 turns the first variable inlet guide vane 1102 in a clockwise direction. Similarly, the mounting 1110 moves the third pin 1114 to cause a leading end 1208 of the third lever arm 1120 to be positioned above a trailing end 1210 of the third lever arm 1120. As a result, the third lever arm 1120 turns the second variable inlet guide vane 1104 in a clockwise direction. Thus, in the actuation system 1100, the direction in which the first variable inlet guide vane 1102 rotates matches the direction in which the second variable inlet guide vane 1104 rotates. Additionally, the direction in which the first and second variable inlet guide vanes 1102, 1104 rotate matches the movement direction of the first pin 1106 and the mounting 1110.

In some examples, the actuation system 1100 causes the positions of the first and second variable inlet guide vanes 1102, 1104 to be adjusted by a same angular displacement (e.g., the same magnitude (e.g., degrees)) (° in the clockwise direction). In some other examples, the actuation system 1100 causes the positions of the first and second variable inlet guide vanes 1102, 1104 to be adjusted by different angular displacements (e.g., different magnitudes (e.g., degrees)) (° in the clockwise direction). For example, a length(s) of the second lever arm 1118 and/or the third lever arm 1120 can be adjusted to configure the magnitudes of angular displacement that the first and second variable inlet guide vanes 1102, 1104 encounter as a result of a unit of rotation of the first pin 1106 and the mounting 1110. Further, a size and/or shape of the mounting 1110 can be adjusted based on the length(s) of the second and third lever arms 1118, 1120 and the desired conversion between the rotation of the first pin 1106 and the angular displacement(s) of the first and second variable inlet guide vanes 1102, 1104.

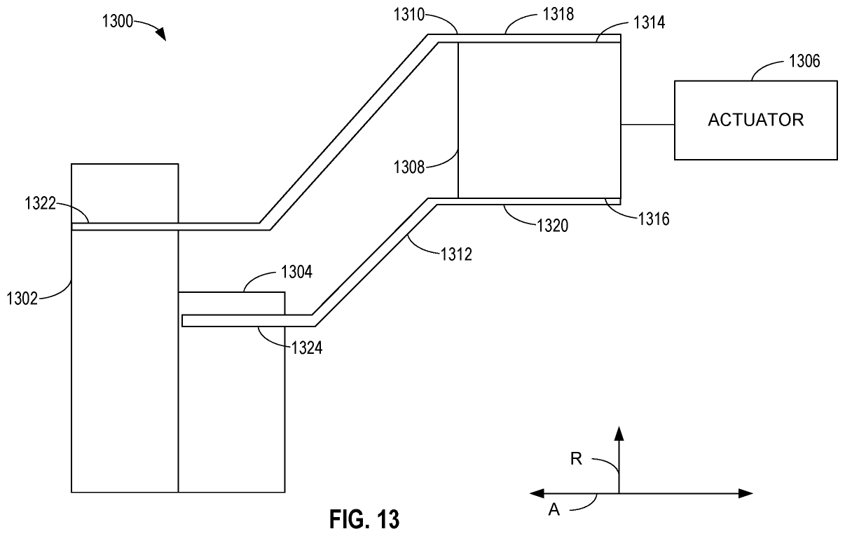

FIG. 13 illustrates another example actuation system 1300 to adjust a pitch of a first variable inlet guide vanes 1302 (e.g., the first variable inlet guide vane 202 of FIG. 2, the first variable inlet guide vane 302 of FIG. 3, the first variable inlet guide vane 402 of FIG. 4) and a second variable inlet guide vane 1304 (e.g., the second variable inlet guide vane 204 of FIG. 2, the second variable inlet guide vane 304 of FIG. 3, the second variable inlet guide vanes 404 of FIG. 4). In FIG. 13, the actuation system 1300 includes an actuator 1306, a ring 1308, a first lever arm 1310, and a second lever arm 1312. In FIG. 13, the actuator 1306 controls a rotational position of the ring 1308. That is, to adjust an angular displacement of the first and second variable inlet guide vanes 1302, 1304, the actuator 1306 can rotate the ring 1308. For example, the actuator 1306 can be implemented by a hydraulic pump or a servo motor that is operatively coupled to the ring 1308 via one or more bell cranks and/or crank and slider linkages to enable the actuator 1306 to control the rotational position of the ring 1308.

In FIG. 13, the first lever arm 1310 and the second lever arm 1312 are pivotably coupled to the ring 1308. In some examples, the first lever arm 1310 is pivotably coupled to the ring 1308 at an outer radial surface 1314 of the ring 1308. In some examples, the second lever arm 1312 is pivotably coupled to the ring 1308 at an inner radial surface 1316 of the ring 1308. Further the first lever arm 1310 is fixedly coupled to the first variable inlet guide vane 1302 (e.g., a shaft or spindle of the first variable inlet guide vane 1302), and the second lever arm 1312 is fixedly coupled to the second variable inlet guide vane 1304 (e.g., a shaft or spindle of the second variable inlet guide vane 1304).

In FIG. 13, when the actuator 1306 rotates the ring 1308 (e.g., in the circumferential direction C of FIG. 1), first ends 1318, 1320 of the lever arms 1310, 1312 (e.g., ends of the lever arms 1310, 1312 pivotably coupled to the ring 1308) move with the ring 1308. As a result, second ends 1322, 1324 of the lever arms 1310, 1312 (e.g., ends of the lever arms 1310, 1312 fixedly coupled to the variable inlet guide vanes 1302, 1304) rotate, which rotates the first variable inlet guide vane 1302 and the second variable inlet guide vane 1304. In FIG. 13, the actuation system 1300 causes the first variable inlet guide vane 1302 and the second variable inlet guide vane 1304 to rotate in a same direction. In some examples, the actuation system 1300 causes angular displacements of the first variable inlet guide vane 1302 and the second variable inlet guide vane 1304 to change at a same rate when the ring 1308 rotates. In some other examples, the actuation system 1300 causes angular displacements of the first variable inlet guide vane 1302 and the second variable inlet guide vane 1304 to change at different rates. For example, a length(s) of the lever arms 1310, 1312 can be shortened to increase the change in angular displacement of the first variable inlet guide vane 1302 and the second variable inlet guide vane 1304 when the ring 1308 rotates.

Although shafts of the variable inlet guide vanes 1302, 1304 are shown in different axial positions in the illustrated example of FIG. 13, it should be understood that the shafts can be positioned in a same axial position when the actuation system 1300 is utilized in conjunction with the variable inlet guide vanes 200 of FIG. 2. In such examples, the shaft that is positioned concentrically within the other shaft extends further radially outward to provide a surface to which the lever arms 1310, 1312 can attach.

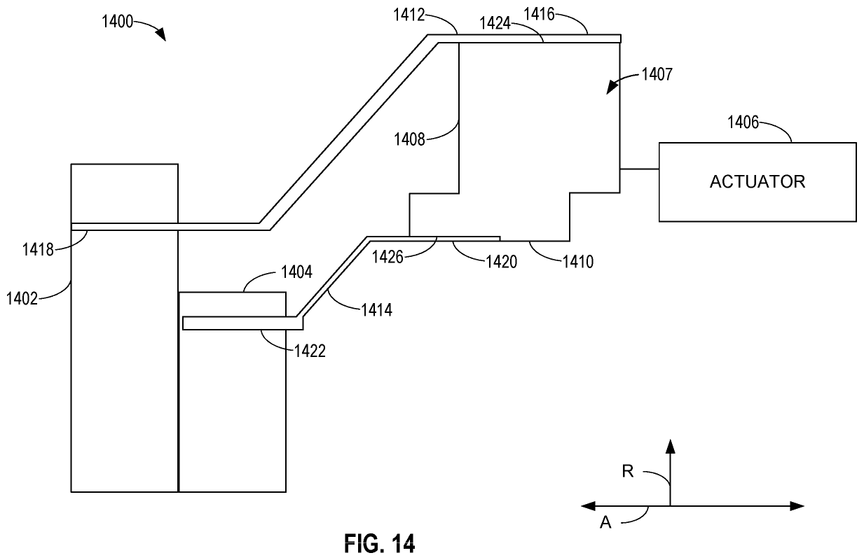

FIG. 14 illustrates another example actuation system 1400 to adjust a pitch of a first variable inlet guide vane 1402 (e.g., the first variable inlet guide vane 202 of FIG. 2, the first variable inlet guide vane 302 of FIG. 3, the first variable inlet guide vane 402 of FIG. 4) and a second variable inlet guide vane 1404 (e.g., the second variable inlet guide vane 204 of FIG. 2, the second variable inlet guide vane 304 of FIG. 3, the second variable inlet guide vanes 404 of FIG. 4). In FIG. 14, the actuation system 1400 includes an actuator 1406, a ring 1407, a first lever arm 1412, and a second lever arm 1414. The ring 1407 includes an outer radial portion 1408 and an inner radial portion 1410. In FIG. 14, the actuator 1406 controls a rotational position of the ring 1407. That is, to adjust an angular displacement of the first variable inlet guide vane 1402 and the second variable inlet guide vane 1404, the actuator 1406 can rotate the ring 1407. For example, the actuator 1306 can be implemented by one or more hydraulic pumps or a servo motors that are operatively coupled to the ring 1407 via one or more bell cranks and/or crank and slider linkages to enable the actuator 1406 to control the rotational position of the ring 1407.

In FIG. 14, a first end 1416 of the first lever arm 1412 is pivotably coupled to the outer radial portion 1408 of the ring 1407. A second end 1418 of the first lever arm 1412 is fixedly coupled to the first variable inlet guide vane 1402 (e.g., a shaft or spindle of the first variable inlet guide vane 1402). Similarly, a first end 1420 of the second lever arm 1414 is pivotably coupled to the inner radial portion 1410 of the ring 1407, and a second end 1422 of the second lever arm 1414 is fixedly coupled to the second variable inlet guide vane 1404 (e.g., a shaft or spindle of the second variable inlet guide vane 1404). In some examples, the first end 1416 of the first lever arm 1412 is coupled to an outer radial surface 1424 of the ring 1407. In some examples, the first end 1420 of the second lever arm 1414 is coupled to an inner radial surface 1426 of the ring 1407.

In FIG. 14, when the actuator 1406 rotates the ring 1407 (e.g., in the circumferential direction C of FIG. 1), the first end 1416 of the first lever arm 1412 moves with the outer radial portion 1408 of the ring 1407. As a result, the second end 1418 of the first lever arm 1412 rotates, which rotates the first variable inlet guide vane 1402. Similarly, when the actuator 1406 rotates the ring 1407 (e.g., in the circumferential direction C of FIG. 1), the first end 1420 of the second lever arm 1414 moves with the inner radial portion 1410, and the second end 1422 of the second lever arm 1414 rotates, which rotates the second variable inlet guide vane 1404.

In some examples, the variable inlet guide vanes 1402, 1404 rotate in the same direction. In FIG. 14, the outer radial portion 1408 of the ring 1407 includes a different geometry than the inner radial portion 1410 to enable a desired angular displacement relationship. More particularly, the inner radial portion 1410 is offset from the outer radial portion 1408 in an axial direction A, which enables the second lever arm 1414 to be shorter than the first lever arm 1412. As a result, a same magnitude of rotation by the outer radial portion 1408 and the inner radial portion 1410 can cause the second variable inlet guide vane 1404 to rotate more than the first variable inlet guide vane 1402.

Although shafts of the variable inlet guide vanes 1402, 1404 are shown in different axial positions in the illustrated example of FIG. 14, it should be understood that the shafts can be positioned in a same axial position when the actuation system 1400 is utilized in conjunction with the variable inlet guide vanes 200 of FIG. 2. In such examples, the shaft that is positioned concentrically within the other shaft extends further radially outward to provide a surface to which the lever arms 1412, 1414 can attach.

From the foregoing, it will be appreciated that example systems, apparatus, articles of manufacture, and methods have been disclosed that reduce non-synchronous vibration that can be encountered in a compressor. As a result, examples herein suppress formation of rotating instabilities associated with non-synchronous vibration and improve engine performance.

Example gas turbine engines including stub-tandem variable inlet guide vanes are disclosed. Further aspects are provided by the subject matter of the following clauses:

A gas turbine engine comprising a compressor, a variable inlet guide vane upstream of the compressor, and a part-span vane positioned between at least a portion of the variable inlet guide vane and the compressor in an axial direction defined by the gas turbine engine.

The gas turbine engine of the preceding clause, wherein the part-span vane includes a first portion and a second portion downstream of the first portion, wherein the first portion overlaps with the variable inlet guide vane in the axial direction, and wherein the second portion is aft of the variable inlet guide vane in the axial direction.

The gas turbine engine of any preceding clause, wherein the variable inlet guide vane includes an upstream portion and a downstream portion, wherein the upstream portion spans a greater distance than the downstream portion in a radial direction defined by the gas turbine engine.

The gas turbine engine of any preceding clause, wherein the part-span vane is a variable part-span vane.

The gas turbine engine of any preceding clause, wherein the variable inlet guide vane includes a first shaft coupled to at least one actuator, wherein the variable part-span vane includes a second shaft coupled to the at least one actuator, and wherein the second shaft is positioned aft of the first shaft.

The gas turbine engine of any preceding clause, wherein the variable part-span vane rotates in a first direction when the variable inlet guide vane rotates in a second direction opposite the first direction.

The gas turbine engine of any preceding clause, wherein the variable part-span vane rotates in a first direction when the variable inlet guide vane rotates in the first direction.

The gas turbine engine of any preceding clause, wherein the variable inlet guide vane and the part-span vane are positioned in a flow path defined between an inner radial surface and an outer radial surface, wherein the variable inlet guide vane includes a first inner radial edge at the inner radial surface and a second outer radial edge at the outer radial surface.

The gas turbine engine of any preceding clause, wherein the variable inlet guide vane includes a first outer radial edge positioned between the first inner radial edge and the second outer radial edge in a radial direction defined by the gas turbine engine.

The gas turbine engine of any preceding clause, wherein the first outer radial edge is downstream of the second outer radial edge.

The gas turbine engine of any preceding clause, wherein the part-span vane overlaps the third radial end in the axial direction.

An apparatus comprising a fan, a compressor downstream of the fan, and stub-tandem variable inlet guide vanes positioned between the fan and the compressor, the stub-tandem variable inlet guide vanes including a first variable inlet guide vane upstream of the compressor, and a second variable inlet guide vane upstream of the compressor and downstream of at least a portion of the first variable inlet guide vane.

The apparatus of any preceding clause, wherein the second variable inlet guide vane is a part-span airfoil.

The apparatus of any preceding clause, wherein the second variable inlet guide vane is cantilevered.

The apparatus of any preceding clause, wherein the first variable inlet guide vane has a first pitch, and wherein the second variable inlet guide vane has a second pitch different from the first pitch.

The apparatus of any preceding clause, wherein an aft portion of the first variable inlet guide vane contacts a forward portion of the second variable inlet guide vane.

The apparatus of any preceding clause, further including an actuator operatively coupled to the first variable inlet guide vane, wherein the actuator is to cause the first variable inlet guide vane to rotate, and wherein the second variable inlet guide vane rotates in an opposite direction from the first variable inlet guide vane when the actuator causes the first variable inlet guide vane to rotate.

An apparatus comprising a first variable inlet guide vane including a first inner radial edge and a first outer radial edge, wherein a first distance from the first inner radial edge to the first outer radial edge defines a height of a flow path, and a second variable inlet guide vane downstream of the first variable inlet guide vane in the flow path, wherein the second variable inlet guide vane includes a second inner radial edge and a second outer radial edge, and wherein a second distance from the second inner radial edge to the second outer radial edge is less than the first distance.

The apparatus of any preceding clause, wherein the first variable inlet guide vane includes a first leading edge and a first trailing edge, and wherein the second variable inlet guide vane includes a second leading edge positioned downstream of the first leading edge and upstream of the first trailing edge in the flow path.

The apparatus of any preceding clause, wherein the first variable inlet guide vane includes a third outer radial edge positioned between the first inner radial edge and the second outer radial edge in a radial direction that defines the height of the flow path.

An apparatus comprising, means for compressing, first means for variably producing aerodynamic forces upstream of the means for compressing, and second means for variably producing aerodynamic forces upstream of the means for compressing and at least partially downstream of the first means for variably producing aerodynamic forces.

The apparatus of any preceding clause, wherein the first means for variably producing aerodynamic forces spans a first distance of a radial length of a flow path, and wherein the second means for variably producing aerodynamic forces spans a second distance of a radial length of the flow path, the second distance different from the first distance.

The apparatus of any preceding clause, further including means for actuating the first means for variably producing aerodynamic forces and the second means for variably producing aerodynamic forces.

The apparatus of any preceding clause, wherein the means for actuating rotates the first means for variably producing aerodynamic forces and the second means for variably producing aerodynamic forces simultaneously in different directions.

The apparatus of any preceding clause, wherein the means for actuating rotates the first means for variably producing aerodynamic forces and the second means for variably producing aerodynamic forces simultaneously in a same direction.

The apparatus of any preceding clause, wherein the means for actuating rotates the first means for variably producing aerodynamic forces independent of the second means for variably producing aerodynamic forces.

The apparatus of any preceding clause, wherein the means for actuating rotates the first means for variably producing aerodynamic forces to a first angular displacement, and wherein the means for actuating rotates the second means for variably producing aerodynamic forces to a second angular displacement different from the first angular displacement.

An apparatus comprising, a first variable inlet guide vane to extend across a first radial portion of a flow path, a second variable inlet guide to extend across a second radial portion of a flow path, the second radial portion different from the first radial portion.

The apparatus of any preceding clause, further including an actuator to rotate the first variable inlet guide vane in a first direction, and wherein the actuator is to rotate the second variable inlet guide vane in a second direction opposite the first direction.

The apparatus of any preceding clause, further including an actuator to rotate the first variable inlet guide vane and the second variable inlet guide vane in a same direction at a same time.

The apparatus of any preceding clause, wherein the actuator rotates the first variable inlet guide to a different angular placement than the second variable inlet guide vane.

The apparatus of any preceding clause, further including one or more actuators to rotate the first variable inlet guide vane independent of the second variable inlet guide vane.

An apparatus comprising, a first variable inlet guide vane including a first portion and a second portion, the first portion having a shorter axial length than the second portion, and a second variable inlet guide vane downstream of and aligned with the second portion of the first variable inlet guide vane in a radial direction, the second variable inlet guide vane not aligned with the first portion of the first variable inlet guide vane in the radial direction.

An apparatus comprising, as first variable inlet guide spanning a radial length of a flow path, and a second variable inlet guide vane downstream of the first variable inlet guide vane and spanning only a portion of the radial length of the flow path.

The apparatus of any preceding clause, wherein the portion is an outer radial portion of the flow path.

An apparatus comprising, an actuator, a first ring, a second ring coupled to the actuator, wherein the first ring or the second ring is coupled to the actuator, a gear positioned between the first ring and the second ring to relay rotation of the first ring or the second ring by the actuator to the second ring or the first ring, a first variable inlet guide vane, a second variable inlet guide vane, a first lever arm including a first end pivotably coupled to the first ring and a second end fixedly coupled to the first variable inlet guide vane, a second lever arm including a third end pivotably coupled to the second ring and a second end fixedly coupled to the first ring.

The apparatus of any preceding clause, further including a casing, a first linkage including a first end coupled to the casing and a second end coupled to the first ring.

The apparatus of any preceding clause, further including a second linkage including a first end coupled to the casing and a second end coupled to the second ring.

The apparatus of any preceding clause, further including a third linkage including a first end coupled to the casing and a second end coupled to the gear between the first ring and the second ring.

The apparatus of any preceding clause, further including a fourth linkage including a first end coupled to the first ring and a second end coupled to the second ring.

An apparatus comprising, a first variable inlet guide vane, a second variable inlet guide aft of at least a portion of the first variable inlet guide vane, wherein a trailing edge of the first variable inlet guide vane overlaps with an axial position of the second variable inlet guide vane at an interface.

The apparatus of any preceding clause, further including an actuator to rotate the first variable inlet guide vane, and wherein the interface causes the second variable inlet guide vane to rotate in an opposite direction from the first variable inlet guide vane.

The apparatus of any preceding clause, wherein the first variable inlet guide vane and the second variable inlet guide vane include orifices through which a pin extends at the interface.

The apparatus of any preceding clause, wherein the first variably inlet guide vane includes an indentation, and wherein the second variably inlet guide vane includes a protrusion that extends into a slot defined by the indentation at the interface.

An apparatus comprising, a first variable inlet guide vane, a second variable inlet guide aft of at least a portion of the first variable inlet guide vane, an actuator, a ring coupled to the actuator, the actuator to rotate the ring, a pin fixedly coupled to the ring, a first lever arm pivotably coupled to the pin and fixedly coupled to the first variable inlet guide vane, and a second lever arm pivotably coupled to the pin and fixedly coupled to the second variable inlet guide vane.

The apparatus of any preceding clause, wherein a rotation of the ring in a first rotational direction causes the first inlet guide vane and the second variable inlet guide vane to rotate in different directions.

An apparatus comprising, a first variable inlet guide vane, a second variable inlet guide aft of at least a portion of the first variable inlet guide vane, an actuator, a ring coupled to the actuator, the actuator to rotate the ring, a first lever arm pivotably coupled to the ring, a first pin, the first lever arm to rotate the pin when the ring rotates, a mounting fixedly coupled to the first pin, the mounting to rotate with the first pin, a second pin coupled to the mounting, a third pin coupled to the mounting, a second lever arm to couple the first variable inlet guide vane to the second pin, and a third lever arm to couple the second variable inlet guide vane to the third pin.

The apparatus of any preceding clause, wherein a rotation of the ring in a first rotational direction causes the first inlet guide vane and the second variable inlet guide vane to rotate in a same direction.

The apparatus of any preceding clause, wherein a rotation of the ring in a first rotational direction causes the first inlet guide vane to change angular displacement by a first degree or magnitude and causes the second variable inlet guide vane change angular displacement by a second degree or magnitude different from the first degree or magnitude.

The apparatus of any preceding clause, wherein a rotation of the ring in a first rotational direction causes the first inlet guide vane to change angular displacement by a same amount as the second variable inlet guide vane.

An apparatus comprising, a first variable inlet guide vane, a second variable inlet guide, an actuator, a ring, a first lever arm to couple the first variable inlet guide vane to the ring, and a second lever arm to couple the second variable inlet guide vane to the ring.

The apparatus of any preceding clause, wherein a rotation of the ring in a first rotational direction causes the first inlet guide vane and the second variable inlet guide vane to rotate in a same direction.

The apparatus of any preceding clause, wherein a rotation of the ring in a first rotational direction causes the first inlet guide vane to change angular displacement by a first degree or magnitude and causes the second variable inlet guide vane change angular displacement by a second degree or magnitude different from the first degree or magnitude.

The apparatus of any preceding clause, wherein a rotation of the ring in a first rotational direction causes the first inlet guide vane to change angular displacement by a same amount as the second variable inlet guide vane.

An apparatus comprising, a first variable inlet guide vane, a second variable inlet guide, at least one actuator, a first ring coupled to the at least one actuator, a second ring coupled to the at least one actuator, a first lever arm to couple the first variable inlet guide vane to the first ring, a second lever arm to couple the second variable inlet guide vane to the second ring.

The apparatus of any preceding clause, wherein the at least one actuator causes a first rotation of the first ring in a first direction, and wherein the at least one actuator causes a second rotation of the second ring in a second direction opposite the first direction, the second rotation to occur at a same time as the first rotation.

The apparatus of any preceding clause, wherein the at least one actuator causes a first rotation of the first ring in a first direction, and wherein the at least one actuator causes a second rotation of the second ring in the first direction, the second rotation to occur at a same time as the first rotation.

The apparatus of any preceding clause, wherein the at least one actuator causes the first inlet guide vane to change angular displacement by a first degree or magnitude and causes the second variable inlet guide vane change angular displacement by a second degree or magnitude different from the first degree or magnitude.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A gas turbine engine comprising:
a compressor;
a variable inlet guide vane upstream of the compressor; and
a part-span vane positioned between at least a portion of the variable inlet guide vane and the compressor in an axial direction defined by the gas turbine engine.

2. The gas turbine engine of claim 1, wherein the part-span vane includes a first portion and a second portion downstream of the first portion, wherein the first portion overlaps with the variable inlet guide vane in the axial direction, and wherein the second portion is aft of the variable inlet guide vane in the axial direction.

3. The gas turbine engine of claim 1, wherein the variable inlet guide vane includes an upstream portion and a downstream portion, wherein the upstream portion spans a greater distance than the downstream portion in a radial direction defined by the gas turbine engine.

4. The gas turbine engine of claim 1, wherein the part-span vane is a variable part-span vane.

5. The gas turbine engine of claim 4, wherein the variable inlet guide vane includes a first shaft coupled to at least one actuator, wherein the variable part-span vane includes a second shaft coupled to the at least one actuator, and wherein the second shaft is positioned aft of the first shaft.

6. The gas turbine engine of claim 4, wherein the variable part-span vane rotates in a first direction when the variable inlet guide vane rotates in a second direction opposite the first direction.

7. The gas turbine engine of claim 4, wherein the variable part-span vane rotates in a first direction when the variable inlet guide vane rotates in the first direction.

8. The gas turbine engine of claim 1, wherein the variable inlet guide vane and the part-span vane are positioned in a flow path defined between an inner radial surface and an outer radial surface, wherein the variable inlet guide vane includes a first inner radial edge at the inner radial surface and a second outer radial edge at the outer radial surface.

9. The gas turbine engine of claim 8, wherein the variable inlet guide vane includes a first outer radial edge positioned between the first inner radial edge and the second outer radial edge in a radial direction defined by the gas turbine engine.

10. The gas turbine engine of claim 9, wherein the first outer radial edge is downstream of the second outer radial edge.

11. The gas turbine engine of claim 10, wherein the part-span vane overlaps the first outer radial edge in the axial direction.

12. An apparatus comprising:
a fan;
a compressor downstream of the fan; and
stub-tandem variable inlet guide vanes positioned between the fan and the compressor, the stub-tandem variable inlet guide vanes including:
a first variable inlet guide vane upstream of the compressor; and
a second variable inlet guide vane upstream of the compressor and downstream of at least a portion of the first variable inlet guide vane.

13. The apparatus of claim 12, wherein the second variable pitch airfoil spans only a portion of a radial height of a flow path between the fan and the compressor.

14. The apparatus of claim 12, wherein the second variable inlet guide vane is cantilevered.

15. The apparatus of claim 12, wherein the first variable inlet guide vane has a first pitch, and wherein the second variable inlet guide vane has a second pitch different from the first pitch.

16. The apparatus of claim 12, wherein an aft portion of the first variable inlet guide vane contacts a forward portion of the second variable inlet guide vane.

17. The apparatus of claim 16, further including an actuator operatively coupled to the first variable inlet guide vane, wherein the actuator is to cause the first variable inlet guide vane to rotate, and wherein the second variable inlet guide vane rotates in an opposite direction from the first variable inlet guide vane when the actuator causes the first variable inlet guide vane to rotate.

18. An apparatus comprising:
a first variable inlet guide vane including a first inner radial edge and a first outer radial edge, wherein a first distance from the first inner radial edge to the first outer radial edge defines a height of a flow path; and
a second variable inlet guide vane downstream of the first variable inlet guide vane in the flow path, wherein the second variable inlet guide vane includes a second inner radial edge and a second outer radial edge, and wherein a second distance from the second inner radial edge to the second outer radial edge is less than the first distance.

19. The apparatus of claim 18, wherein the first variable inlet guide vane includes a first leading edge and a first trailing edge, and wherein the second variable inlet guide vane includes a second leading edge positioned downstream of the first leading edge and upstream of the first trailing edge in the flow path.

20. The apparatus of claim 18, wherein the first variable inlet guide vane includes a third outer radial edge positioned between the first inner radial edge and the second outer radial edge in a radial direction that defines the height of the flow path.
